(19) United States
(12) Patent Application Publication
(10) Pub. No.: US 2005/0019451 A1
(43) Pub. Date: Jan. 27, 2005

(54) Candy holder and display device

(76) Inventor: Gina Margiotta, Congers, NY (US)

Correspondence Address: Gina Margiotta, 172-1 North Route 303, Congers, NY, 10920, US

(21) Appl. No.: 10/626,162

(22) Filed: Jul. 24, 2003

(51) Int. Cl. A23G 1/00; B65D 85/00

(52) U.S. Cl. 426/104; 426/134; 426/110

(57) ABSTRACT

The present invention is a novelty candy holding device for displaying and holding candy or confectioneries. The present invention is a unique and decorative way of displaying and holding candy or confectioneries. The novelty candy holding device comprises a doll and candy-holding means, wherein the candy-holding means is designed to look like the doll's hair.

### SUMMARY OF THE INVENTION

The present invention is a novelty candy holding device for displaying and holding candy or confectioneries. The present invention is a unique and decorative way of displaying and holding candy or confectionaries. The novelty candy holding device for displaying and holding candy comprises a doll, said doll comprising a spherical head and candy-holding means, wherein a first end of the candy-holding means holds the candy and a second end of the candy-holding means is attached to the head.

### BRIEF DESCRIPTION OF THE DRAWINGS

FIG. 1 is a front view of a novelty candy holding device comprised of a doll having a head and hair, which holds the candy, and a stand.

FIG. 2 is a close-up view of a candy-holding means (2) which holds a piece of candy (3) on one end and is attached to the head (1) on the other.

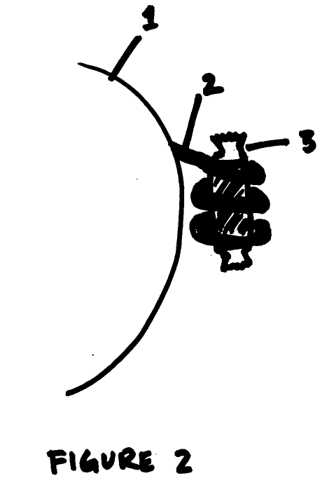

### DETAILED DESCRIPTION OF THE INVENTION

The present invention is a novelty candy holding device for a displaying and holding candy or confectionaries. The device is comprised of a doll, which can be male or female. The doll comprises a head and candy is attached to the head in a manner that represents hair. The head of the doll is a sphere comprised of a material into which candy-holding means can be inserted and held in place, such as a topiary ball. The sphere is painted on two sides, one reflecting the color of the doll's hair and the other the color of the doll's skin. The head is attached to a doll torso and legs, which can be made of wood, plastic or any other material strong enough to support the head. The candy is disposed in a candy-holding means, such as chenille stems, pipecleaners or other similar material, wherein the first end of the candy-holding means holds the candy and the second end of the candy-holding means is attached to the head on the side of the sphere painted the color of the doll's hair. The candy-holding means is attached to the head by inserting the second end into the head such that the candy-holding means is held firmly in place. The color of the chenille stems can be any color and can be shaped to resemble straight hair, curly hair, ponytails or any other hair style.

The doll torso and legs are painted in any desired colors and is attached to the head with glue or other similar method. Eyes and a mouth are inserted into the head on the side painted the color of the doll's skin to create a face. The eyes may be comprised of pegs. The mouth is comprised of beads, preferably red, strung on a wire.

The stand the doll is set upon may be a flower pot or any other shape that will provide stability to the doll and allow the doll to stand upright. The flower pot may be comprised of a terra cotta pot, which may be painted any desired color. The flower pot may also be comprised of green crinkle paper to simulate grass.

In a preferred embodiment, the topiary ball used for the doll's head is at least three inches in diameter and the torso and legs are comprised of wood.

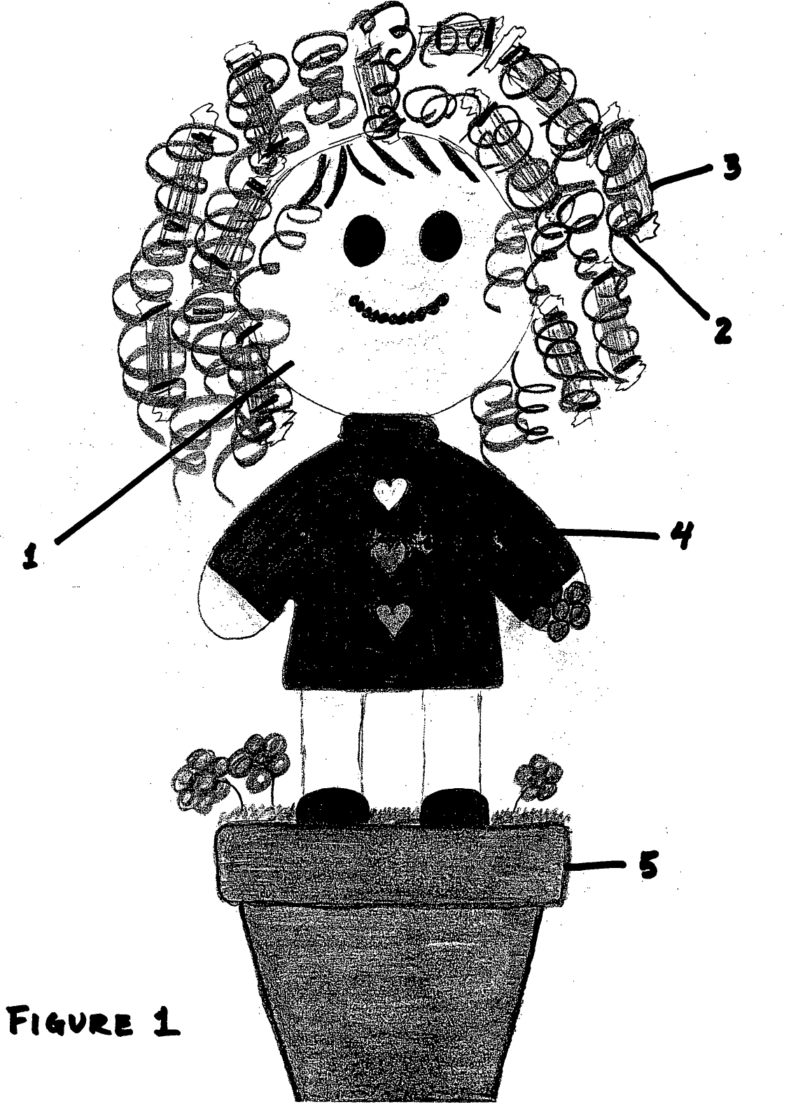

For example, FIG. 1 shows one embodiment of the present invention. The candy holder is comprised of a spherical head (1), candy-holding means such as chenille stems (2) holding candy (3), such as Tootsie Rolls, on one end of the candy-holding means and the other end of the candy-holding means inserted into the head, a torso (4) and a stand (5). FIG. 1 shows an embodiment with the hair designed in a curly style. Other types of candy and different colors of chenille stems may be used to create individualized candy holders.

While this invention has been particularly shown and described with references to preferred embodiments thereof, it will be understood by those skilled in the art that various changes in form and details may be made therein without departing from the meaning of the invention described. Rather, the scope of the invention is defined by the claims that follow:

1. A novelty candy holding device for displaying and holding candy comprising a doll, said doll comprising a spherical head and candy-holding means, wherein a first end of the candy-holding means holds the candy and a second end of the candy-holding means is attached to the head.

2. The device of claim 1, wherein the head is comprised of a topiary ball.

3. The device of claim 2, wherein the topiary ball is at least three inches in diameter.

4. The device of claim 2, wherein the candy-holding means is comprised of chenille stems.

5. The device of claim 1, wherein the doll further comprises a torso and legs and the device further comprises a stand, which is attached to the doll's legs.

6. The device of claim 5, wherein the stand is comprised of a flower pot.
